(19) United States
(12) Patent Application Publication
(10) Pub. No.: US 2026/0331901 A1
(43) Pub. Date: Oct. 22, 2026

(54) CIRCUIT BREAKER AND METHOD

(71) Applicant: Siemens Aktiengesellschaft, München (DE)

(72) Inventor: Marvin Tannhäuser, Hausen (DE)

(21) Appl. No.: 19/107,731

(22) PCT Filed: Aug. 24, 2023
(86) PCT No.: PCT/EP2023/073193

§ 371 Date: Feb. 28, 2025

(30) Foreign Application Priority Data
Aug. 31, 2022 (DE) 10 2022 209 032.2

(51) Int. Cl. H02H 3/32

(52) U.S. Cl. CPC H02H 3/32

(57) ABSTRACT

A circuit breaker for protecting a low-voltage electrical circuit for AC voltage ascertains the current level of a differential current of conductors of the low-voltage circuit. If first differential current time limit values are exceeded, current flow in the low-voltage circuit is prevented in that switching elements of an electronic interruption unit are in a high-impedance state with isolating contacts being in a closed state, or the isolating contacts are in an open state. If second differential current limit values are exceeded, current flow in the low-voltage circuit is prevented in that the switch elements of the electronic interruption unit are in a high-impedance state with the isolating contacts being in the closed state. A method for operating a circuit breaker for protecting a low-voltage electrical circuit for AC voltage is also provided.

The invention relates to the technical field of a circuit breaker for a low-voltage circuit having an electronic interruption unit according to the preamble of patent claim 1 and a method for a circuit breaker for a low-voltage circuit having an electronic interruption unit.

Low voltage is taken to mean voltages of up to 1000 volts AC voltage or up to 1500 volts DC voltage. Low voltage is taken to mean, in particular, voltages that are greater than the extra-low voltage, having values of 50 volts AC voltage or 120 volts DC voltage.

Low-voltage circuit or network or system is taken to mean circuits having nominal currents or rated currents of up to 125 amps, more specifically up to 63 amps. Low-voltage circuit is taken to mean, in particular, circuits having nominal currents or rated currents of up to 50 amps, 40 amps, 32 amps, 25 amps, 16 amps or 10 amps. The stated current values are taken to mean, in particular, nominal, rated and/or breaking currents, i.e. the maximum current normally carried via the circuit or the current that usually results in the electrical circuit being interrupted, for example by a protective device, such as a circuit breaker, miniature circuit breaker or power breaker. The rated currents can be further graduated from 0.5 A through 1 A, 2 A, 3 A, 4 A, 5 A, 6 A, 7 A, 8 A, 9 A, 10 A, etc. up to 16 A.

Miniature circuit breakers are overcurrent protective devices that have been known for a long time and are employed in low-voltage circuits in electrical installation engineering. They protect lines from damage as a result of heating due to excessively high current and/or short circuit. A miniature circuit breaker can automatically break the circuit in the event of overload and/or short circuit. A miniature circuit breaker is a fusing element that does not automatically reset.

Power breakers, in contrast to miniature circuit breakers, are intended for currents greater than 125 A, in some cases even from as little as 63 amps. Miniature circuit breakers are therefore of simpler and more delicate design. Miniature circuit breakers normally have a mounting option for mounting on what is known as a top-hat rail (mounting rail, DIN rail, TH35 ).

Miniature circuit breakers according to the prior art are of electromechanical design. They have a mechanical switching contact or open-circuit shunt release in a housing in order to interrupt (trip) the electrical current. A bimetallic protective element or bimetallic element is normally used for tripping (interruption) in the event of longer-lasting overcurrent (overcurrent protection) or in the event of thermal overload (overload protection). An electromagnetic trip with a coil is employed for brief tripping when an overcurrent limit value is exceeded or in the event of a short circuit (short circuit protection). One or more arc extinguishing chambers or devices for arc extinction are provided, as well as, in addition, connecting elements for conductors of the electrical circuit that is to be protected.

Fault current circuit breakers for electrical circuits, in particular for low-voltage circuits or systems, are generally known. Fault current circuit breakers are also referred to as residual current devices, RCD for short. Fault current circuit breakers determine the total current in an electrical circuit, which is normally zero, and interrupt the electrical circuit if a differential current value, i.e. a total current that is not equal to zero and is above a specific (differential) current value or fault current value, is exceeded.

Almost all previous fault current circuit breakers have a summation current transformer, the primary winding of which is formed by the conductors of the circuit and the secondary winding of which delivers the total current, which is used directly or indirectly to interrupt the electrical circuit.

For this purpose, two or more conductors, usually outgoing and return conductors or outer and neutral conductors in a single-phase AC network, all three outer conductors or all three outer conductors and the neutral conductor in a three-phase AC network, are routed through a current transformer that usually has an annular core made of ferromagnetic material. Only the differential current, i.e. a current that differs from the outgoing and return currents, from the conductors is converted. The total current in an electrical circuit is usually equal to zero. Fault currents can therefore be detected.

If, for example, a current flows away to ground on the energy sink side or the load side, this is referred to as a fault current in this context. There is a fault, for example, when there is an electrical connection from a phase conductor of the electrical circuit to ground, for example when a person touches the phase conductor. Part of the electrical current then flows back not via the neutral conductor or zero conductor, as usual, but rather via the person and ground. This fault current can now be sensed by means of the summation current transformer since the absolute value of the sensed total of the current flowing out and the current flowing back is not equal to zero. The circuit, e.g. at least one line, some of the lines or all of the lines, is interrupted via a relay or a holding magnet release, for example with a connected mechanism. Fault current circuit breakers for sensing AC fault currents are known generally from the document DE 44 32 643 A1.

The main function of fault current circuit breakers is to protect individuals from electrical currents (electric shock) and to protect systems, machines or buildings from fire caused by electrical insulation faults.

If the fault current circuit breaker or its summation current transformer is designed such that the secondary-side energy of the summation current transformer is sufficient to actuate a release unit or an interruption unit or a release, such fault current circuit breakers are referred to as being independent of the line voltage.

If auxiliary energy that is generally generated by a power supply unit provided in the fault current circuit breaker is required or used for the trip circuit, such fault current circuit breakers are referred to as being dependent on the line voltage. That is to say that fault current circuit breakers that are dependent on the line voltage contain a power supply unit for supplying energy to a fault current detection means (not independent of the line voltage). These power supply units are needed, for example, to detect fault currents in DC voltage networks and mixed DC/AC networks or in circuits with high frequencies.

Circuit breakers having an electronic interruption unit are relatively new developments. They have a semiconductor-based electronic interruption unit. That is to say that the flow of electric current in the low-voltage circuit is carried via semiconductor components or semiconductor switches that are able to interrupt the flow of electric current or to be switched on. Circuit breakers having an electronic interruption unit frequently also have a mechanical isolating contact system, in particular having isolator properties according to relevant standards for low-voltage circuits, the contacts of the mechanical isolating contact system being connected in series with the electronic interruption unit, i.e. the current in the low-voltage circuit to be protected is carried via both the mechanical isolating contact system and the electronic interruption unit.

The present invention relates, in particular, to low-voltage AC circuits having an AC voltage, usually having a time-dependent sinusoidal AC voltage at the frequency f. The temporal dependence of the instantaneous voltage value u(t) of the AC voltage is described by the equation:

u(t)=U*sin (2π*f*t),

where:

u(t)=instantaneous voltage value at the time t

U=amplitude of the voltage

A harmonic AC voltage can be represented by the rotation of a phasor, the length of which corresponds to the amplitude (U) of the voltage. The instantaneous deflection is the projection of the phasor onto a coordinate system. An oscillation period corresponds to one full revolution of the phasor, and the full angle thereof is 2π(2pi) or 360°. The angular frequency is the rate of change of the phase angle of this rotating phasor. The angular frequency of a harmonic oscillation is always 2π times its frequency, i.e.:

ω=2π*f=2π/T=angular frequency of the AC voltage

(T=period duration of the oscillation)

It is often preferred to state the angular frequency (ω) rather than the frequency (f), since many formulae in oscillation theory can be represented more compactly using the angular frequency due to the occurrence of trigonometric functions, the period of which is by definition 2π:

u(t)=U*sin (ωt)

In the case of angular frequencies that are not constant over time, the term instantaneous angular frequency is also used.

In the case of a sinusoidal AC voltage, in particular an AC voltage that is constant over time, the time-dependent value formed from the angular velocity ω and the time t corresponds to the time-dependent angle φ(t), which is also referred to as the phase angle φ(t). That is to say that the phase angle φ(t) periodically passes through the range 0 . . . 2π or 0° . . . 360°.

That is to say that the phase angle periodically assumes a value of between 0 and 2π or 0° and 360° (φ=n*(0 . . . 2π) or φ=n*(0° . . . 360°) on account of periodicity; in abbreviated form: φ=0 . . . 2π or φ=0° . . . 360°) .

Instantaneous voltage value u(t) or instantaneous current value or instantaneous differential current value is therefore taken to mean the instantaneous value of the voltage/current/differential current at the time t, i.e. in the case of a sinusoidal (periodic) AC voltage the value of the voltage/current/differential current at the phase angle φ(φ=0.2π or φ=0° . . . 360°, of the respective period).

The object of the present invention is to improve a circuit breaker of the type cited at the outset, in particular to guarantee protection against fault currents caused by individuals while maintaining simultaneous security of supply or availability of electrical systems, i.e. to achieve immunity to technology-contingent (fault) currents that would lead to spurious tripping of the circuit breaker. That is to say firstly to ensure protection of individuals and secondly to improve security of supply in a low-voltage circuit. Alternatively, the object is to provide a novel concept for such a circuit breaker.

This object is achieved by a circuit breaker having the features of patent claim 1 and by a method according to patent claim 12.

The invention provides for a circuit breaker for protecting a low-voltage electrical circuit, in particular low-voltage AC circuit, comprising:
a housing having grid-side and load-side connections for conductors of the low-voltage circuit,
a differential current sensor unit, for determining the level of a differential current on the conductors of the low-voltage circuit, in particular for sensing the time characteristic of the instantaneous value of the differential current,
a mechanical isolating contact unit that has a closed state of the contacts for a flow of current in the low-voltage circuit or an open state of the contacts for a current-flow-preventing electrical isolation in the low-voltage circuit; the mechanical isolating contact unit is in particular able to be operated and switched by way of a mechanical handle, and so opening of contacts to prevent a flow of current or closing of the contacts for a flow of current in the low-voltage circuit is able to be controlled (by way of the handle), and thus (in particular) electrical isolation in the low-voltage circuit is able to be controlled;
   in the case of a mechanical isolating contact unit, opening contacts is also referred to as isolation and closing contacts is referred to as connection;
an electronic interruption unit that is connected, on the circuit side, in series with the mechanical isolating contact unit and that, by way of semiconductor-based switching elements, has a high-impedance (in particular nonconductive) state of the switching elements to prevent a flow of current or a low-impedance state of the switching elements for a flow of current in the low-voltage circuit;
   in the case of an electronic interruption unit, a high-impedance (in particular nonconductive) state of the switching elements (to prevent a flow of current) is also referred to as the off state (process: disconnection) and a low-impedance (conductive) state of the switching elements (for a flow of current) is also referred to as the on state (process: connection);
a control unit that is connected to the differential current sensor unit, the mechanical isolating contact unit and the electronic interruption unit.

According to the invention, the circuit breaker, in particular the control unit, is configured in such a way that exceedance of first differential current time limit values (in particular by absolute values) results in a prevention of a flow of current in the low-voltage circuit being initiated
a) by way of a high-impedance state of the switching elements of the electronic interruption unit when the isolating contacts are in the closed state or
b) by way of an open state of the isolating contacts.

Furthermore, exceedance of a second differential current limit value by absolute values results in a prevention of a flow of current in the low-voltage circuit being initiated by way of a high-impedance state of the switching elements of the electronic interruption unit when the isolating contacts are in the closed state.

This has the particular advantage that there is provision for two evaluations for the sensed differential current.

On the one hand, in respect of a first differential current time limit value, which corresponds to a conventional evaluation such as those used in fault current circuit breakers according to the prior art today. The result of the evaluation may be two possible preventions of a flow of current, however. Firstly, a conventional prevention of a flow current in the low-voltage circuit by way of an open state of the isolating contacts, i.e. electrical isolation. Secondly, a novel prevention as a result of a high-impedance state of the switching elements of the electronic interruption unit when the isolating contacts are in the closed state.

The RMS value of the differential current can advantageously be used for evaluating the first differential current time limit value. By way of example, an RMS (Root Mean Square) value is used to determine the differential current. Exceedance of the relevant standards-compliant (RC circuit breaker) current/time limit values results in one of the two cited preventions of the flow of current being effected.

On the other hand, a parallel evaluation of a second differential current limit value, advantageously using the instantaneous value of the differential current, that an immediate breaking in the event of exceedance by absolute values “immediately” initiates a high-impedance state of the switching elements of the electronic interruption unit when the isolating contacts are in the closed state.

Advantageously, exceedance of the second differential current limit value results in the prevention of the flow of current in the low-voltage circuit being effected by way of a high-impedance state of the switching elements of the electronic interruption unit within a first break time. The first break time is in particular less than 20 ms, specifically less than 15 ms, 10 ms, 5 ms, 1 ms, 500 μs or 100 μs.

Advantageously, the prevention of the flow of current in the low-voltage circuit brought about by the exceedance of the second differential current limit value is followed by the switching elements of the electronic interruption unit changing to low impedance.

This has the particular advantage that automatic reconnection takes place and thus high availability of the power supply is achieved.

The change to low impedance takes place in particular when the absolute value of the instantaneous value of the AC voltage (applied to the circuit breaker) is less than a first voltage limit. The first voltage limit is in particular less than 10 volts or less than 5 volts. More specifically, the switching elements of the electronic interruption unit can change to low impedance at a zero crossing of the AC voltage. That is to say that the circuit breaker switches to the standby state and, e.g. on the next voltage zero crossing, automatically back to the on state.

This furthermore has the particular advantage that an erroneous differential current event, for example brought about by a (phase) conductor being touched by a person (critical event) or by a technology-contingent leakage current (not critical for individuals, i.e. noncritical event) (for example as a result of switched capacitors), is followed by an immediate prevention of a flow of current in the low-voltage circuit being initiated by way of a high-impedance state of the switching elements of the electronic interruption unit.

The prevention of the flow of current by way of a high-impedance state of the switching elements of the electronic interruption unit and a closed state of the contacts by way of the second differential current limit values is followed by a change to low impedance taking place, and so it is also possible to check for the occurrence of erroneous differential current events. As such, critical events can be distinguished from noncritical events, to provide maximum security of power supply in the circuit, so as firstly to ensure protection of individuals and secondly to ensure the availability of systems.

As such, the state at the load-side connections can be monitored further in respect of the existence of differential current limit values or differential current time limit values. A change of state can advantageously result in another action taking place, for example according to the other advantageous configurations of the invention.

As such, a completely novel protection concept or operating concept for an (RC) circuit breaker is presented.

Other advantageous configurations of the invention are specified in the subclaims and in the exemplary embodiment.

Advantageously, the mechanical handle is able to be used to operate in particular only the mechanical isolating contact unit. Connection and disconnection by means of the electronic interruption unit is not able to be controlled (directly) on the device.

In One advantageous configuration of the invention, the change to low impedance is followed by a renewed exceedance of the second differential current limit value being detected. A change to high impedance with a subsequent change to low impedance takes place. If renewed exceedances of the second differential current limit value take place (with changes to high impedance and low impedance), this is carried out only until there is a first number of exceedances.

The electronic interruption unit then remains in a high-impedance state. This can be effected until another time limit has been exceeded. Alternatively or additionally, this state can be communicated by way of a communication unit.

Alternatively or additionally, the contacts of the mechanical isolating contact unit can be opened.

This has the particular advantage that a design for a robust circuit breaker exists that ensures high availability of the power supply.

In one advantageous configuration of the invention, the circuit breaker is configured in such a way that the second differential current limit value has a higher absolute value than a first differential current limit value or the first differential current time limit value (the differential current component). In particular, the second differential current limit value is a value from the range of 2 to 100 times the first differential current limit value or first differential current time limit value.

This has the particular advantage that the immediate breaking is performed only when an instantaneous value of the differential current arises that is constantly greater than the continuously permissible differential current. Additionally, adjustability of the second differential current limit value permits the limit or threshold to be matched to the given operating situation and the existing operational events or disruptions with a differential current consequence.

In one advantageous configuration of the invention, there is provision for a voltage sensor unit connected to the control unit, for determining the level of a voltage of the conductors of the low-voltage circuit, in particular instantaneous values of the voltage. The circuit breaker is configured in such a way that the prevention of the flow of current in the low-voltage circuit brought about by the exceedance of the second differential current limit value is followed by the switching elements of the electronic interruption unit changing to low impedance, the change to low impedance taking place in particular when the absolute value of the instantaneous value of the AC voltage is less than a first voltage limit.

The first voltage limit is, by way of example, less than 20 volts or less than 10 volts or less than 5 volts. In particular, the switching elements of the electronic interruption unit change to low impedance at a zero crossing of the AC voltage.

In one advantageous configuration of the invention, there is provision for a current sensor unit connected to the control unit, for determining the level of a current on the conductors of the low-voltage circuit. The circuit breaker, in particular the control unit, is configured in such a way that exceedance of first current limit values or first current time limit values results in a prevention of a flow of current in the low-voltage circuit being initiated by way of a high-impedance state of the switching elements of the electronic interruption unit when the isolating contacts are in the closed state.

This has the particular advantage that, in addition to the differential current sensing and the associated protection functions, there is also overcurrent/short circuit current sensing, and so a combined fault current/line protection circuit breaker advantageously exists.

In one advantageous configuration of the invention, the mechanical isolating contact unit is associated with the load-side connections.

This has the particular advantage that an architecture that lends support to the inventive behavior f the circuit breaker exists, since on the one hand a high-impedance interruption unit results in the flow of current being interrupted, but the circuit breaker continues to be supplied with power even when the contacts are open, which means that operation in accordance with the invention can continue.

The invention claims a corresponding method for a circuit breaker for a low-voltage circuit comprising electronic (semiconductor-based) switching elements having the same and further advantages.

The invention claims a corresponding computer program product for a circuit breaker. The computer program product comprises commands that, when the program is executed by a microcontroller, cause said microcontroller to carry out or facilitate the inventive configurations or methods of the circuit breaker. In particular,
exceedance of first differential current time limit values results in a prevention of a flow of current in the low-voltage circuit being initiated
a) by way of a high-impedance state of the switching elements of the electronic interruption unit when the isolating contacts are in the closed state or
b) by way of an open state of the isolating contacts;
exceedance of a second differential current limit value results in a prevention of a flow of current in the low-voltage circuit being initiated by way of a high-impedance state of the switching elements of the electronic interruption unit when the isolating contacts are in the closed state.

The microcontroller is part of the circuit breaker, in particular of the control unit.

The invention claims a corresponding computer-readable storage medium on which the computer program product is stored.

The invention claims a corresponding data carrier signal that transmits the computer program product.

All configurations, both in dependent form referring back to patent claim 1 or 11 and referring back only to individual features or combinations of features of patent claims, in particular also a reference from the dependent arrangement claims back to the independent method claim, improve a circuit breaker, in particular improve safety for individuals and security of supply in low-voltage circuits, and provide a novel safe concept for a circuit breaker.

The described properties, features and advantages of this invention and the manner in which they are achieved become clearer and more distinctly comprehensible in connection with the following description of the exemplary embodiments, which are outlined in more detail in connection with the drawing.

In the drawing:

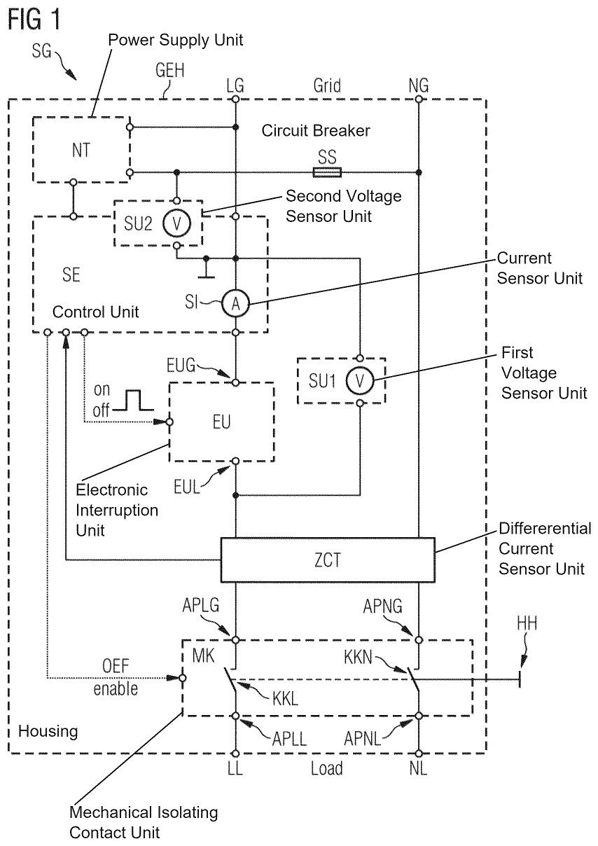

FIG. 1 shows a first block diagram of a circuit breaker,

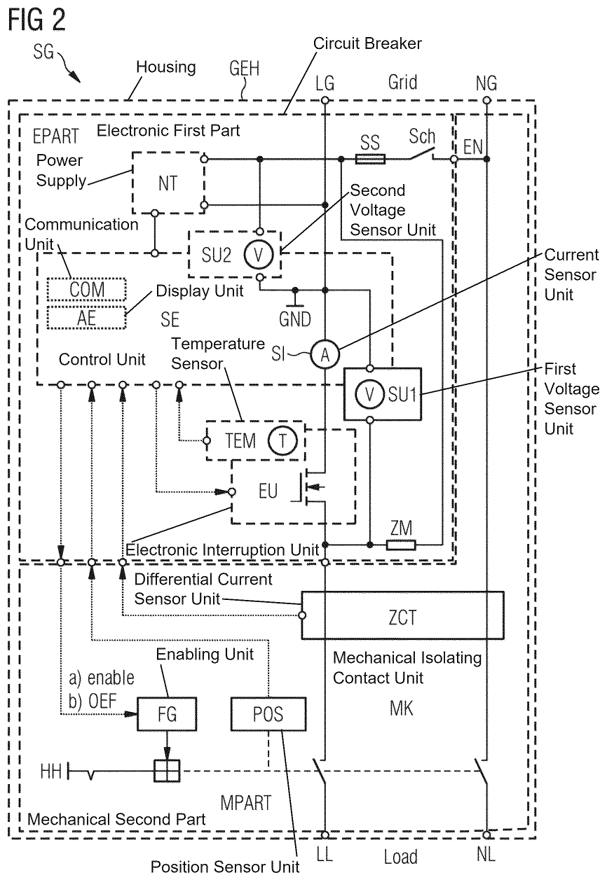

FIG. 2 shows a second block diagram of a circuit breaker,

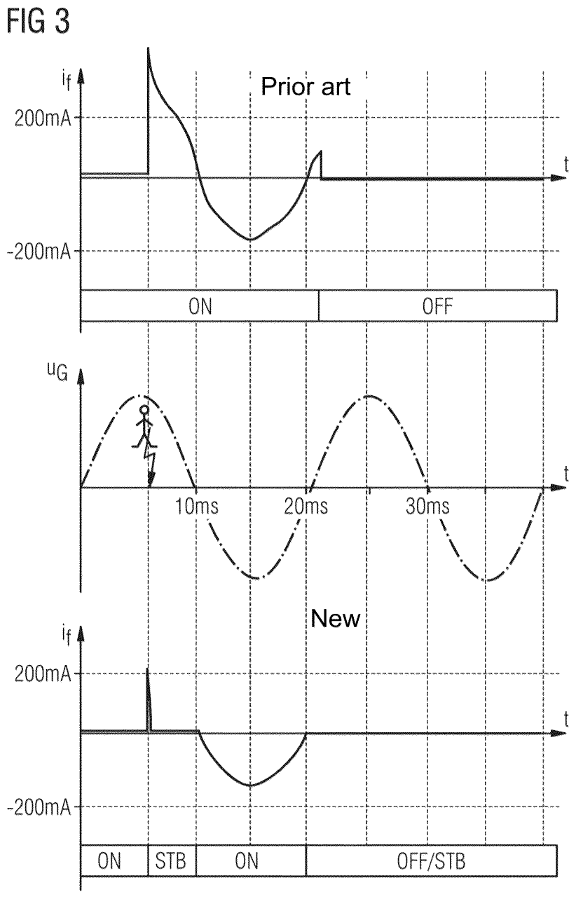

FIG. 3 shows a first representation of a switching behavior,

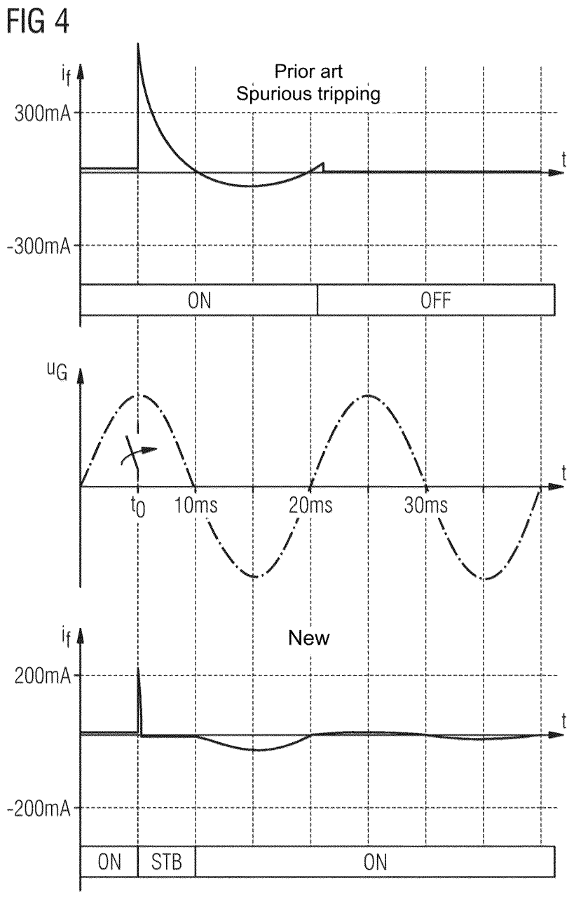

FIG. 4 shows a second representation of a switching behavior,

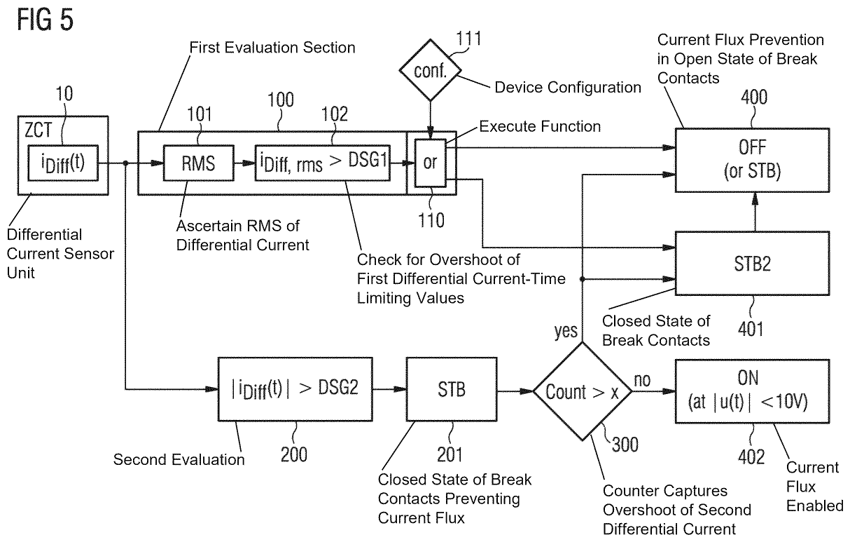

FIG. 5 shows a diagram of an operating sequence.

FIG. 1 shows a diagram of a circuit breaker SG for protecting a low-voltage electrical circuit, in particular a low-voltage AC circuit, having a housing GEH, comprising:
grid-side connections, which in the example comprise a grid-side neutral conductor connection NG and a grid-side phase conductor connection LG,
load-side connections, which in the example comprise a load-side neutral conductor connection NL and a load-side phase conductor connection LL,
the connections are intended for the low-voltage circuit;
the grid-side connections/the grid side Grid normally have/has an energy source connected to them/it,
the load-side connections/the load side Load normally have/has a load connected to them/it;
a (double-pole) mechanical isolating contact unit MK having load-side terminals APLL, APNL and grid-side terminals APLG, APNG,
   there being provision for a load-side terminal APNL for the neutral conductor, a load-side terminal APLL for the phase conductor, a grid-side terminal APNG for the neutral conductor and a grid-side terminal APLG for the phase conductor. The load-side terminals APNL, APLL are connected to the load-side neutral and phase conductor connections NL, LL, and so opening of contacts KKN, KKL to prevent a flow of current or closing of the contacts KKN, KKL for a flow of current in the low-voltage circuit is able to be controlled,
an, in particular single-pole, electronic interruption unit EU, (which, in the single-pole version, is in particular arranged in the phase conductor,)
   having a grid-side connecting point EUG, which is electrically connected to the grid-side phase conductor connection LG, and
   a load-side connecting point EUL, which is electrically connected, or is connected, to the grid-side terminal APLG of the mechanical isolating contact unit MK,
   wherein the electronic interruption unit EU, by way of semiconductor-based switching elements (not shown), has, or is switchable to, a high-impedance state of the switching elements to prevent a flow of current or a low-impedance state of the switching elements for a flow of current in the low-voltage circuit,
a differential current sensor unit ZCT, for determining the level of a differential current (in particular the time characteristic of the instantaneous value of the differential current) on the conductors of the low-voltage circuit; the differential current sensor unit ZCT in the example is arranged between the electronic interruption unit EU and the mechanical isolating contact unit MK, or it may alternatively be provided (arranged) between the mechanical isolating contact unit MK and the load-side neutral and phase conductor connections NL, LL, or also alternatively provided (arranged) between the electronic interruption unit EU and the grid-side connections NG, LG. The differential current sensor unit ZCT determines the level of the differential current on the conductors (to be protected) of the low-voltage circuit that are routed through the circuit breaker. In the example, the neutral conductor and the phase conductor in the case of a single-phase AC circuit.

The differential current sensor unit ZCT may be a conventional summation current transformer. The primary side of the summation current transformer is formed by the conductors of the low-voltage circuit (the phase conductor and the neutral conductor in the example). The secondary side of the summation current transformer is connected to the control unit SE.
(optionally) a current sensor unit SI, for determining the level of the current in the low-voltage circuit, which is in particular arranged in the current path of the phase conductor, or phase conductor current path,
a control unit SE that is connected to the differential current sensor unit ZCT, (optionally) to the current sensor unit SI, to the mechanical isolating contact unit MK and to the electronic interruption unit EU.

According to the invention, the circuit breaker SG, in particular the control unit SE, is configured in such a way
that exceedance of first differential current time limit values DSG1 (i.e. a differential current limit value is exceeded for a first period of time; i.e. when the level of the differential current exceeds the first differential current limit value for a first period of time) results in a prevention of a flow of current in the low-voltage circuit being initiated
a) by way of a high-impedance state of the switching elements of the electronic interruption unit when the isolating contacts are in the closed state or
b) by way of an open state of the isolating contacts.

(One of the two variants may be implemented. Alternatively, both variants may be implemented and a user can configure or select a prevention in advance.)

This can be accomplished for example by using the RMS value of the differential current in respect of the exceedance of the first differential current time limit values DSG1. RMS value formation already forms a time average.

According to the invention, the circuit breaker, in particular the control unit SE, is furthermore configured in such a way
that exceedance of a second differential current limit value DSG2 results in a prevention of a flow of current in the low-voltage circuit being initiated by way of a high-impedance state of the switching elements of the electronic interruption unit when the isolating contacts are in the closed state.

This is advantageously accomplished by using the instantaneous value of the differential current in respect of the exceedances of the second differential current limit value DSG2.

As such, exceedance of the second differential current limit value DSG2 can result in the prevention of the flow of current in the low-voltage circuit being effected by way of a high-impedance state of the switching elements of the electronic interruption unit within first break time, which is in particular less than ms, specifically less than 15 ms, 10 ms, 5 ms, 1 ms, 500 μs or 100 μs. This produces an almost immediate breaking.

The optionally provided current sensor unit SI connected to the control unit SE, for determining the level of a current on the conductors of the low-voltage circuit, can configure the circuit breaker SG in such a way that exceedance of first current limit values (i.e. when the level of the current exceeds the (absolute value of) the first current limit value) or first current time limit values (i.e. the first current limit value is exceeded for a first period of time; i.e. when the level of the (absolute value of the) current exceeds the first current limit value for a first period of time) results in a prevention of a flow of current in the low-voltage circuit being initiated by way of a high-impedance state of the switching elements of the electronic interruption unit when the isolating contacts are in the closed state.

The mechanical isolating contact unit MK in the example is arranged on the load side; the electronic interruption unit EU, according to the invention, is arranged on the grid side. The grid side GRID with the energy source is normally live. The load side LOAD usually has an electrical load connected to it.

This has the advantage that there are no other (in particular live) parts or components between the contacts of the mechanical isolating contact unit/load-side terminals (APLL, APNL) of the mechanical isolating contact unit and the two load-side connections (LL, NL). As such, this architecture or design makes it possible to ensure that under no circumstances is a voltage applied to the load-side connections LL, NL when the contacts KKL, KKN are open. This increases the safety of the protective device.

By contrast, in other architectures, in which the mechanical isolating contact unit is arranged on the grid side, there are often electronic units (which are not electrically isolated) upstream of the load-side connection.

The circuit breaker may be configured in such a way that the level of the voltage across the electronic interruption unit is able to be determined. That is to say that the level of a first voltage between the grid-side connecting point EUG and the load-side connecting point EUL of the electronic interruption unit EU is able to be determined, or is determined.

This is accomplished, in the example according to FIGS. 1, by virtue of there being provision for a first voltage sensor unit SUI that is connected to the control unit SE and determines the level of the voltage between the grid-side connecting point EUG and the load-side connecting point EUL of the electronic interruption unit EU.

When voltage is measured by the first voltage sensor unit SU1, the voltage across the series connection comprising the electronic interruption unit EU and the current sensor SI can alternatively also be determined, as shown in FIG. 1. The current sensor unit SI has a very low internal impedance, and so determination of the level of the voltage is not impaired or is impaired insignificantly.

The circuit breaker may be configured in such a manner that there is provision for a second voltage sensor unit SU2 that determines the level of the voltage between the grid-side neutral conductor connection NG and the grid-side phase conductor connection LG.

The first voltage sensor unit can also be replaced by using two voltage measurements (upstream of the electronic interruption unit and downstream of the electronic interruption unit). Calculating a difference is used to determine the voltage across the electronic interruption unit.

There may thus be provision for a/the second voltage sensor unit SU2, which is connected to the control unit SE and determines the level of a second voltage between the grid-side neutral conductor connection NG and the grid-side phase conductor connection LG. Furthermore, there may be provision for a third voltage sensor unit SU (not shown) that is connected to the control unit and determines the level of a third voltage between the grid-side neutral conductor connection NG and the load-side connecting point EUL of the electronic interruption unit EU. The circuit breaker is configured in such a way that the difference between the second and third voltages is used to determine the level of a/the first voltage between the grid-side connecting point EUG and the load-side connecting point EUL of the electronic interruption unit EU.

The grid-side terminals APLG, APNG of the mechanical isolating contact unit MK may have a measuring impedance ZM connected between them. The measuring impedance ZM can be an electrical resistor and/or capacitor, for example. The measuring impedance can furthermore be an inductor. In particular, the measuring impedance can be a series connection or parallel connection comprising a resistor and/or a capacitor and/or an inductor.

In the example according to FIG. 1, the electronic interruption unit EU is of single-pole design, in the phase conductor in the example. In this arrangement, the grid-side terminal APNG for the neutral conductor of the mechanical isolating contact unit MK is connected to the grid-side neutral conductor connection NG of the housing GEH.

The circuit breaker SG is advantageously configured in such a way that the contacts of the mechanical isolating contact unit MK can be opened by the control unit SE, but not closed, this being indicated by an arrow from the control unit SE to the mechanical isolating contact unit MK.

The mechanical isolating contact unit MK is able to be operated by way of a mechanical handle HH on the circuit breaker SG in order to control manual (by hand) opening or closing of the contacts KKL, KKN. The mechanical handle HH indicates the switching state (open or closed) of the contacts of the mechanical isolating contact unit MK, in particular by way of a (purely) mechanical connection, on the circuit breaker.

In addition, the contact position (or the position of the handle, closed or open) may be able to be transferred to the control unit SE. The contact position (or the position of the handle) can be determined e.g. by means of a sensor, such as a position sensor. The contact position or the switching state can be transferred to the control unit SE. The position sensor may be a part of the mechanical isolating contact unit MK. Alternatively, the position sensor may be a component in the electronic first part (EPART, FIG. 2). By way of example, there may be provision in the electronic first part (EPART) for a Hall sensor that contactlessly detects and transfers the position of the contacts and/or the handle.

The mechanical isolating contact unit MK is advantageously configured in such a way that the contacts can be (manually) closed by way of the mechanical handle only after an enable (Enable), in particular an enable signal. This is also indicated by the arrow from the control unit SE to the mechanical isolating contact unit MK. That is to say that the contacts KKL, KKN of the mechanical isolating contact unit MK can be closed by way of the handle HH only when the enable or the enable signal (from the control unit) is present. Without the enable or the enable signal, although the handle HH can be actuated, the contacts cannot be closed (“continuous slip”).

The circuit breaker SG has a power supply or power supply unit NT, for example a switched-mode power supply unit. In particular, the power supply/power supply unit NT is intended for the control unit SE, this being indicated in FIG. 1 by a connection between the power supply/power supply unit NT and the control unit SE. The power supply/power supply unit NT is (secondly) connected to the grid-side neutral conductor connection NG and the grid-side phase conductor connection LG. There may advantageously be provision in the connection to the grid-side neutral conductor connection NG (and/or phase conductor connection LG) for a fuse SS, in particular a fusible link, or a switch Sch (FIG. 2).

According to the invention, the power supply unit NT is normally continuously supplied with power, specifically by the grid-side connections. It is protected by the fuse SS if necessary or can be switched off by the switch Sch.

Advantageously, the switch Sch may be designed such that the switch can be opened only when the contacts are in the open state. This increases the safety of the device, since the electronics (in particular the control unit) cannot be switched off when the contacts are closed.

The fuse SS does not just have the purpose of protecting the power supply by means of the power supply unit NT, but is also intended, in particular in the case of a two-part design (see FIG. 2), to protect the “electronic” first part EPART or, in particular, all of the units thereof (such as specifically the control unit, the electronic interruption unit, possibly the voltage sensor unit(s), the differential current sensor unit, possibly the current sensor unit, possibly the measuring impedance, etc. ).

Alternatively, the measuring impedance ZM may be connected to the grid-side neutral conductor connection NG via the fuse SS. It is thus advantageously possible to produce a three-pole electronic unit or an electronic first part EPART (FIG. 2), for example as a module that has three connections in respect of the low-voltage circuit, a neutral conductor connection and two phase conductor connections. The electronic first part EPART can have other connections, in particular for control or measurement information, such as for an enable signal Enable/enable, an open signal OEF, position information (from the position unit POS) and/or a differential current signal (level of the differential current) from the differential current sensor unit ZCT.

By way of example, the electronic unit or electronic first part EPART (FIG. 2) comprises the electronic interruption unit EU, the control unit SE, the power supply NT (in particular including the fuse SS), the current sensor unit SI, optionally the first voltage sensor unit SU1 and/or optionally the second voltage sensor unit SU2.

With regard to the three connections in respect of the low-voltage circuit of the electronic first part EPART, there is thus the advantage that only two phase conductor connections need to have a high current-carrying capability (several amps, in order to carry the load current) and the neutral conductor connection need only have a (comparatively) low current-carrying capability (for example less than 1 A, a few mA—depending on the energy requirements of the control unit). This simplifies the design and increases the safety of the device, since a fault in the electronic first part EPART cannot result in a large short-circuit current flowing via this connection.

The low-voltage circuit may be a three-phase AC circuit, having a neutral conductor and three phase conductors. The circuit breaker may therefore be a three-phase variant and, by way of example, can have further grid-side and load-side phase conductor connections. There is analogously provision between each of the further grid-side and load-side phase connections for inventive electronic interruption units and contacts of the mechanical isolating contact unit. The respective conductors (three phase conductors L1, L2, L3, neutral conductor N) are routed through the differential current unit ZCT.

There may also be provision for current sensor units and voltage determinations (e.g. by way of first voltage sensor units).

High-impedance is taken to mean a state in which only a current of negligible magnitude flows. In particular, high-impedance is taken to mean impedance values of greater than 1 kiloohm, preferably greater than 10 kiloohms, 100 kiloohms, 1 megaohm, 10 megaohms, 100 megaohms, 1 gigaohm or greater.

Low-impedance is taken to mean a state in which the current value indicated on the circuit breaker could flow. In particular, low-impedance is taken to mean impedance values that are less than 10 ohms, preferably less than 1 ohm, 100 milliohms, 10 milliohms, 1 milliohm or less.

FIG. 2 shows a diagram according to FIG. 1, with the difference that the circuit breaker is of two-part design. It contains an electronic first part EPART, for example on a printed circuit board.

The first part EPART can comprise the control unit SE, the first voltage sensor unit SU1, the second voltage sensor unit SU2, the current sensor unit SI, the electronic interruption unit EU and the power supply NT. Furthermore, the first part can comprise the fusible link SS, a switch Sch, the measuring impedance ZM, a temperature sensor TEM (in particular for the electronic interruption unit EU), a communication unit COM, a display unit AE and, as a variant, a position sensor unit POS.

The electronic first part EPART has only three connections to the low-voltage circuit:
the grid-side phase conductor connection LG as first connection,
a (second) connection for or to the grid-side phase conductor terminal APLG of the mechanical isolating contact unit MK,
a third connection EN for a connection to the grid-side neutral conductor connection NG.

The two connections: to the grid-side phase conductor connection LG and for or to the grid-side phase conductor terminal APLG have a high current-carrying capability, e.g. several amps, greater than 10 A/16 A—depending on the nominal current or rated current of the low-voltage circuit, in particular in order to carry the load current even in the event of short circuit or overload.

The third connection EN for the connection to the grid-side neutral conductor connection NG has a (comparatively) low current-carrying capability, e. g. less than 1 A, a few mA—depending on the energy requirements of the units supplied with power, specifically in the electronic first part EPART. The third connection EN is designed to have a low current-carrying capability in order to supply the power supply unit with current and in order to permit a voltage measurement between the phase conductor and the neutral conductor of the low-voltage circuit. In particular, this third connection EN is protected by means of a fuse SS. This can be provided by way of a fusible link or an inexpensive conductor track fuse (thin conductor track of appropriate length and thickness on the printed circuit board). This has the particular advantage that the lower current-carrying capability in this line or on this third connection EN improves protection against a short circuit that occurs within the electronic first part (EPART) (or (electronic) units), e. g. at the power supply unit or the control unit.

That is to say that loss or failure of an electronic component of a unit within the electronic first part EPART cannot result in a dangerous short-circuit current arising (supplied by the grid-side connections LG, NG) that could lead to a fire in the device.

This short-circuit current is supplied by the grid via the grid-side connections. An upstream circuit breaker often has a much higher tripping current and feeds low-voltage circuits provided in parallel. If there is a fault in the circuit breaker (the circuit breaker of the protected low-voltage circuit) and the upstream circuit breaker trips, faultless parallel circuits would therefore also be broken, which is thus prevented.

The communication unit COM may, in particular, be a wireless communication unit. The communication unit COM can comprise a (manual) input unit on the circuit breaker, for (manually) acknowledging states on the circuit breaker SG. The acknowledgement can also be provided (by wire and/or wirelessly) via the communication unit COM.

Furthermore, the communication unit COM can have a display function. There may also be provision for a separate display unit.

The circuit breaker contains a, in particular mechanical, second part MPART. The second part MPART can comprise the mechanical isolating contact unit MK, the handle HH and an enabling unit FG. Furthermore, the second part can comprise a position unit POS, for reporting the position of the contacts of the mechanical isolating contact unit MK to the control unit, and also the (neutral conductor) connection(s). The second part MPART comprises the differential current sensor unit ZCT, such as a summation current transformer, as is known from conventional fault current circuit breakers, for example.

There may be provision for other units, which are not designated in more detail.

The division advantageously permits an inventive compact circuit breaker having a simplified design to be provided.

The enabling unit/enable function FG enables actuation of the contacts of the mechanical isolating contact unit by way of the handle HH when an enable signal enable is present. That is to say that it is possible to close the contacts KKL, KKN by way of the handle only when the enable signal enable (from the control unit SE) is present. Otherwise, closing is not possible (continuous slip of the handle HH). The contacts remain in the open position/switching state. Furthermore, the enabling unit FG can open the contacts (second function of the enabling unit FG) when an open signal OEF (from the control unit SE) is present. The enabling unit/enable function FG then acts as a tripping unit for opening the contacts of the mechanical isolating contact unit MK.

The circuit breaker SG, in particular the control unit SE, is furthermore configured in such a way that exceedance of current limit values or current time limit values (i.e. when a current limit value is exceeded for a specific period of time) results in a prevention of a flow of current in the low-voltage circuit being initiated, in particular in order to prevent a short-circuit current. This is achieved in particular by virtue of the electronic interruption unit EU changing from the low-impedance state to the high-impedance state. The prevention of a flow of current in the low-voltage circuit is initiated for example by way of a first interruption signal that is transmitted from the control unit SE to the electronic interruption unit EU.

The mechanical isolating contact unit MK can alternatively or additionally be driven by the control unit SE in order to initiate a prevention of a flow of current in the low-voltage circuit in the event of current limit values or current time limit values being exceeded. Specifically, an electrical isolation is possibly brought about in this case. The prevention of a flow of current is initiated, or a possibly electrical interruption of the low-voltage circuit is effected, for example by way of a second interruption signal that is transmitted from the control unit SE to the mechanical isolating contact system MK.

The electronic interruption unit EU can comprise semiconductor components such as bipolar transistors, field-effect transistors (FET), isolated gate bipolar transistors (IGBT), metal oxide layer field-effect transistors (MOSFET) or other (self-commutated) power semiconductors. In particular IGBTs and MOSFETs are particularly well suited to the circuit breaker according to the invention on account of low forward resistances, high junction resistances and a good switching response.

Mechanical isolating contact unit MK is taken to mean in particular a (standards-compliant) isolating function, provided by the isolating contact unit MK. Isolating function is taken to mean the points:
minimum air gap according to standard (voltage-dependent) (minimum distance between the contacts),
contact position indication for the contacts of the mechanical isolating contact system,
it is always possible for the mechanical isolating contact system to be opened (no immobilization of the isolating contact system—in particular by way of the handle, trip-free mechanism)

Within the context of the invention, the series of standards DIN EN 60947, or IEC 60947, which are mentioned here by way of reference, is relevant to the isolator function and the properties thereof in this instance.

The circuit breaker may be configured as a top hat rail mounted circuit breaker SG having a width of e.g. 1 M, 1.5 M or 2 M with two-pole connections (L, N). In electrical installation and control cabinet design, the width of built-in devices, such as circuit breakers, miniature circuit breakers, fault current circuit breakers, etc., is expressed in modules, M for short. The width of a module is ~18 mm. According to DIN standard 43880: 1988-12, the built-in width of devices is intended to be between 17.5 and 18.0 mm, or to be calculated by multiplying this dimension by 0.5 or an integer multiple thereof, that is to say: k×0.5×18 mm or k×0.5×17.5 mm (where k=1, 2, 3, . . . ) . Thus, for example, a single-pole miniature circuit breaker according to the prior art has a width of 1 M. According to DIN 43871, “Consumer units for built-in equipment up to 63 A”, built-in units of electrical panelboards are geared to modules, e.g. the width of mounting rails/top hat rails.

According to the invention, the circuit breaker SG, in particular the control unit SE, is configured in such a way that exceedance of first differential current time limit values results in a prevention of a flow of current in the low-voltage circuit being initiated e. g. by way of a high-impedance state of the switching elements of the electronic interruption unit when the isolating contacts are in the closed state. The first differential current time limit values may be limit values according to relevant standards, such as DIN EN 61008-1. By way of example, 30 mA and a time of 300 ms, 150 ms, 40 ms or 20 ms for protection of individuals in Europe in a 230 volt low-voltage circuit, 6 mA and the same times for protection of individuals in North America, and 300 mA and the same times for protection against fire (230 volts RMS).

The second differential current limit value DSG2 may have a higher absolute value than the first differential current time limit value DSG1. In particular, the second differential current limit value DSG2 is a value from the range of 2 to 100 times the first differential current time limit value DSG1 .

The second differential current limit value DSG2 may have a value of 200 mA, for example. That is to say that, by way of example, arrival at a differential current value of 200 mA results in an (almost) immediate prevention of the flow of current, i.e. in particular in less than 20 ms, specifically less than 15 ms, 10 ms, 5 ms, 1 ms, 500 μs or 100 μs.

The prevention of the flow of current in the low-voltage circuit brought about by the exceedance of the second differential current limit value DSG2 is followed in one configuration by the switching elements of the electronic interruption unit changing to low impedance. The change to low impedance takes place in particular when the absolute value of the instantaneous value of the AC voltage is less than a first voltage limit. The first voltage limit may be less than 10 volts or less than 5 volts, for example. More specifically, the switching elements of the electronic interruption unit change to low impedance at a zero crossing of the AC voltage. The change to low impedance is followed by a renewed exceedance of the second differential current limit value DSG2 being detected. A renewed change to high impedance with a subsequent change to low impedance can then take place until there is a first number (x) of exceedances. The first number of exceedances may be a value from the range 2 or 3 to 20 exceedances, for example. If this first number (x) of exceedances is exceeded, the contacts of the mechanical isolating contact unit MK are opened (for electrical isolation), for example. Alternatively, the electronic interruption unit can also remain in the high-impedance state.

The respective states can be reported via the communication unit or displayed via the display unit AE.

FIG. 3 shows an illustration of the aforementioned response for a differential current if brought about for example by a ground fault current. The top graph in FIG. 3 shows the level or the time characteristic of the differential current i_{f} over time t with associated prevention of a flow of current OFF by way of an open state of the isolating contacts (electrical isolation) or flow of current ON (=current flow capability of the circuit breaker) for a fault current circuit breaker according to the prior art.

The middle graph shows the level or the time characteristic of the AC voltage u_{G} in the (for example 50 Hz) low-voltage circuit on the grid-side connections of the circuit breaker over time t (in milliseconds ms).

The bottom graph shows the level or the time characteristic of the differential current i_{f} over time t with associated events, which are designated as follows:
OFF=prevention of a flow of current by way of an open state of the isolating contacts (electrical isolation),
STB=a prevention of a flow of current by way of a high-impedance state of the electronic interruption unit EU,
ON=current flow capability of the of the circuit breaker) for an inventive circuit breaker.

In the top graph for the response of a fault current circuit breaker according to the prior art, an event that brings about a differential current, for example a ground fault current, occurs at the time t of approximately 5 ms. In the example, the level of the differential current is approximately 400 mA. In the case of a conventional fault current circuit breaker, the prevention of a flow of current OFF (switching off) is then effected after approximately 17 ms (time approximately 22 ms). That is to say that a flow of current ON takes place in the low-voltage circuit from the event until the prevention of the flow of current, and only then is the prevention of the flow of current OFF effected by way of open contacts.

In the bottom graph for the response of an inventive circuit breaker, an event that brings about a differential current, for example a ground fault current, occurs at the time t of approximately 5 ms. In the example, the level of the differential current would theoretically likewise reach a value of approximately 400 mA. According to the invention, an (almost) immediate prevention of a flow current is effected within the break time when the second differential current limit value DSG2, for example 200 mA, is reached, with the result that the potential differential current of e.g. 400 mA is not reached (limiting). The prevention of the flow of current is effected by way of a high-impedance state of the switching elements of the electronic interruption unit STB, for example as a result of an instantaneous value evaluation of the level of the differential current by means of the control unit SE.

By way of example, the switching elements of the electronic interruption unit EU subsequently change to low impedance when the absolute value of the instantaneous value of the AC voltage is less than a first voltage limit. In the example according to FIG. 3, the switching elements of the electronic interruption unit change to low impedance at a zero crossing of the AC voltage, specifically at the next (or next but one) zero crossing of the AC voltage (for example depending on the time of occurrence of the event that brings about the differential current). If the differential current if subsequently reaches the first differential current time limit value DSG1, a prevention of the flow of current in the low-voltage circuit is effected, as shown. By way of example, the prevention of the flow of current is performed at the next zero crossing of the AC voltage, as shown. The prevention of the flow of current can be effected STB by way of a high-impedance state of the switching elements of the electronic interruption unit when the isolating contacts are in the closed state. The prevention of the flow of current can alternatively (conventionally) be effected by way of an open state of the isolating contacts OFF.

That is to say that, in the inventive circuit breaker, exceedance of the second differential current limit value DSG2 and almost immediate prevention of the flow of current in the low-voltage circuit are followed by a renewed change to low impedance (for test purposes) in order to check for the occurrence of the event that brings about the differential current.

FIG. 4 shows a representation according to FIG. 3, with the difference that, by way of illustration, the mentioned response is shown for a differential current i_{f} brought about for example by an operational impulse differential current.

In the top graph for the response of a fault current circuit breaker according to the prior art, an event that brings about a differential current, for example an operational impulse differential current or technology-contingent impulse differential current, as can occur in the low-voltage AC circuit for example during switching operations, in particular switching-on processes and in frequency converters, occurs at the time t of approximately 5 ms. Such impulse differential currents are usually noncritical from the point of view of protection of individuals, since they are brought about not by individuals but rather by less than ideal technical circuits. In the past, steps were taken to make conventional fault current circuit breakers resistant to operational impulse differential currents or technology-contingent impulse differential currents, in order to prevent (technology-contingent) spurious tripping or to achieve high security of supply in the low-voltage circuit. In the example, the level of the differential current is (again) approximately greater than 400 mA. In the case of a conventional fault current circuit breaker according to the prior art, the prevention of a flow of current OFF (open contacts, switching off) is then effected after approximately 17 ms (time approximately 22 ms)—falling edge of the impulse differential current. That is to say that a flow of current ON takes place in the low-voltage circuit from the event until the prevention of the flow of current, and only then is the prevention of the flow of current OFF effected by way of open contacts.

In the bottom graph for the response of an inventive circuit breaker, an event that brings about a differential current, in the example the operational impulse differential current or technology-contingent impulse differential current, occurs at the time t of approximately 5 ms.

In the example, the level of the differential current would theoretically likewise reach a value of approximately or greater than 400 mA. According to the invention, an (almost) immediate prevention (in particular within the break time) of a flow of current STB (high-impedance interruption unit) is effected when the second differential current limit value DSG2, for example 200 mA, is reached, with the result that the potential differential current of e.g. (greater than) 400 mA is not reached (limiting). The prevention of the flow of current is effected by way of a high-impedance state of the switching elements of the electronic interruption unit STB, for example as a result of the instantaneous value evaluation of the level of the differential current by means of the control unit SE.

By way of example, the switching elements of the electronic interruption unit EU subsequently change to low impedance when the absolute value of the instantaneous value of the AC voltage is less than a first voltage limit. In the example according to FIG. 4, the switching elements of the electronic interruption unit change to low impedance at a zero crossing of the AC voltage, specifically at the next (or next but one) zero crossing of the AC voltage (for example depending on the time occurrence of the event that brings about the differential current).

If the differential current if subsequently reaches the first differential current time limit value DSG1, a prevention of the flow of current in the low-voltage circuit would be effected. If the first differential current time limit value DSG1 or second differential current limit value DSG2 is not reached, as shown, the electronic interruption unit remains in the low-impedance state for a flow of current ON, as shown.

FIG. 5 shows a diagram of an operating sequence comprising various function blocks or state blocks. A differential current sensor unit ZCT/10 determines the level of a differential current on the conductors of the low-voltage circuit and acquires or provides instantaneous values of the differential current, which are relayed to a control unit SE, for example.

The instantaneous values of the differential current of the differential current sensor unit ZCT/10 are firstly supplied to a first evaluation section 100, which for example determines an RMS value (root mean square=rms) of the differential current I_{Diff,rms}, block RMS/101, and checks it in respect of exceedance of the first differential current time limit values DSG1 “I_{Diff,rms}>DSG1”/102. Exceedance of the first differential current time limit values DSG1 results in a prevention of a flow of current in the low-voltage circuit being effected
a) by way of a high-impedance state of the switching elements of the electronic interruption unit when the isolating contacts are in the closed state “standby” block STB2/401
b) by way of an open state of the isolating contacts OFF/400=>block OFF.

Whether a) or b) is performed or/110 is determined by a device configuration conf/111 or is selected/stipulated.

The instantaneous values of the differential current are secondly supplied to a second evaluation section “|i_{Diff,rms}(t)|>DSG2” 200, which, in the example, uses the absolute value of the instantaneous value of the differential current in respect of the exceedances of the second differential current limit value DSG2. Exceedances of the second differential current limit value DSG2 results in a prevention of a flow of current in the low-voltage circuit being initiated by way of a high-impedance state of the switching elements of the electronic interruption unit when the isolating contacts are in the closed state STB=>block STB/201.

The prevention of the flow current in the low-voltage circuit by way of a high-impedance state of the switching elements of the electronic interruption unit STB is effected within a first break time, which is in particular less than 20 ms, specifically less than 15 ms, 10 ms, 5 ms, 1 ms, 500 μs or 100 μs.

The prevention of the flow of current STB/201 is followed 10 by the switching elements of the electronic interruption unit changing to low impedance ON/402, the change to low impedance taking place in particular when the absolute value of the instantaneous value of the AC voltage is less than a first voltage limit, for example less than 10 volts “(at |u(t)|<10 V)”/402.

If the change to low impedance is followed by a renewed exceedance of the second differential current limit value DSG2, this is recorded by a counter 300. If a first number x of exceedances is exceeded, the contacts of the mechanical isolating contact unit MK are in particular opened to prevent a flow of current OFF=>block OFF/400. Alternatively, a continuous or intermittently i continuous high-impedance state of the switching elements of the electronic interruption unit can also be adopted when the isolating contacts are in the closed state STB2/401=>block STB2/401.

If the first number has not yet been reached, the switching elements of the electronic interruption unit change to low impedance for a flow of current ON=>block ON/block 402.

The circuit breaker SG, in particular the control unit SE, can comprise a microcontroller (=microprocessor) on which a computer program product runs, comprising commands that, when the program is executed by the microcontroller, cause said microcontroller to perform a check (as described above and below) for a circuit breaker.

The computer program product may advantageously be stored on a computer-readable storage medium, such as a USB stick, CD-ROM, etc., in order e.g. to permit an upgrade to an extended version.

The computer program product can alternatively also advantageously be transmitted by a data carrier signal. The control unit SE may:
be realized using a digital circuit, e.g. comprising a (further) microprocessor; the (further) microprocessor may also contain an analog part;
be realized using a digital circuit comprising analog circuit parts.

Although the invention has been illustrated and described more thoroughly in detail by way of the exemplary embodiment, the invention is not limited by the disclosed examples, and other variations can be derived therefrom by a person skilled in the art without departing from the scope of protection of the invention.

1-20. (canceled)

21. A circuit breaker for protecting a low-voltage electrical circuit for AC voltage, the circuit breaker comprising:
a housing having grid-side and load-side connections for conductors of the low-voltage circuit;
a differential current sensor unit for determining a level of a differential current on the conductors of the low-voltage circuit;
a mechanical isolating contact unit including isolating contacts having a closed state for a flow of current in the low-voltage circuit or an open state for a current-flow-preventing electrical isolation in the low-voltage circuit;
an electronic interruption unit having a circuit side connected in series with said mechanical isolating contact unit, said electronic interruption unit including semiconductor-based switching elements having a high-impedance state preventing a flow of current or a low-impedance state for a flow of current in the low-voltage circuit;
a control unit connected to said differential current sensor unit, to said mechanical isolating contact unit and to said electronic interruption unit;
the circuit breaker or said control unit being configured to cause exceeding of first differential current time limit values to result in initiating prevention of a flow of current in the low-voltage circuit:
a) by way of a high-impedance state of said switching elements of said electronic interruption unit when said isolating contacts are in a closed state, or
b) by way of an open state of said isolating contacts; and
exceeding of a second differential current limit value resulting in a prevention of a flow of current in the low-voltage circuit being initiated by way of a high-impedance state of said switching elements of said electronic interruption unit when said isolating contacts are in the closed state.

22. The circuit breaker according to claim 21, wherein an RMS value of the differential current is used to determine the exceeding of the first differential current time limit values.

23. The circuit breaker according to claim 21, wherein an instantaneous value of the differential current is used to determine the exceeding of the second differential current limit value.

24. The circuit breaker according to claim 21, wherein the exceeding of the second differential current limit value results in the prevention of the flow of current in the low-voltage circuit being effected by way of a high-impedance state of said switching elements of said electronic interruption unit within a first break time being less than 20 ms.

25. The circuit breaker according to claim 21, wherein:
the prevention of the flow of current in the low-voltage circuit brought about by the exceeding of the second differential current limit value is followed by said switching elements of said electronic interruption unit changing to low impedance;
a voltage sensor unit is connected to said control unit for determining a level of a voltage of the conductors of the low-voltage circuit; and
the change to low impedance takes place when an absolute value of the instantaneous value of the AC voltage is less than a first voltage limit.

26. The circuit breaker according to claim 25, wherein:
the first voltage limit is less than 20 volts; and
said switching elements of said electronic interruption unit change to low impedance at a zero crossing of the AC voltage.

27. The circuit breaker according to claim 25, wherein:
the change to low impedance is followed by detecting a renewed exceeding of the second differential current limit value, and a change to high impedance with a subsequent change to low impedance takes place until the exceeding occurs a first number of times; and
said isolating contacts of said mechanical isolating contact unit are then opened.

28. The circuit breaker according to claim 21, wherein the second differential current limit value has a higher absolute value than a first differential current limit value or the first differential current time limit value, and the second differential current limit value is a value having a range of 2 to 100 times a first differential current limit value or the first differential current time limit value.

29. The circuit breaker according to claim 21, which further comprises:
a current sensor unit connected to said control unit for determining the level of the current on the conductors of the low-voltage circuit; and
the circuit breaker or said control unit being configured to cause exceeding of first current limit values or first current time limit values to result in a prevention of a flow of current in the low-voltage circuit being initiated by way of a high-impedance state of said switching elements of said electronic interruption unit when said isolating contacts are in the closed state.

30. The circuit breaker according to claim 21, wherein said mechanical isolating contact unit is associated with said load-side connections.

31. A method for operating a circuit breaker for protecting a low-voltage electrical circuit for AC voltage, the method comprising:
determining a level of a differential current on conductors of the low-voltage circuit;
initiating a prevention of a flow of current in the low-voltage circuit when exceeding first differential current time limit values:
a) by way of a high-impedance state of switching elements of an electronic interruption unit when isolating contacts are in a closed state, or
b) by way of an open state of the isolating contacts; and
initiating prevention of a flow of current in the low-voltage circuit when exceeding a second differential current limit value by way of a high-impedance state of the switching elements of the electronic interruption unit when the isolating contacts are in the closed state.

32. The method according to claim 31, which further comprises using an RMS value of the differential current for determining the exceeding of the first differential current limit values or first differential current time limit values.

33. The method according to claim 31, which further comprises using an instantaneous value of the differential current for determining the exceeding of the second differential current limit value.

34. The method according to claim 31, which further comprises causing exceeding of the second differential current limit value to result in the prevention of the flow of current in the low-voltage circuit being effected by way of a high-impedance state of the switching elements of the electronic interruption unit within a first break time being less than 20 ms.

35. The method according to claim 31, which further comprises:
carrying out the prevention of the flow of current in the low-voltage circuit by exceeding the second differential current limit value followed by the switching elements of the electronic interruption unit changing to low impedance; and
carrying out the change to low impedance when an absolute value of an instantaneous value of the AC voltage is less than a first voltage limit.

36. The method according to claim 35, which further comprises following the change to low impedance by detecting renewed exceeding of the second differential current limit value, and carrying out a change to high impedance with a subsequent change to low impedance until the exceeding occurs a first number of times; and
then opening the contacts of the mechanical isolating contact unit.

37. The method according to claim 31, which further comprises determining a level of a current on the conductors of the low-voltage circuit, and causing exceeding of first current limit values or first current time limit values to result in initiation of a prevention of a flow of current in the low-voltage circuit by way of a high-impedance state of the switching elements of the electronic interruption unit when the isolating contacts are in the closed state.

38. A non-transitory computer program product, comprising commands that, upon executing the program on a microcontroller, cause the microcontroller to facilitate or carry out the method according to claim 31.

39. A non-transitory computer-readable storage medium on which the computer program product according to claim 38 is stored.

40. A data carrier signal transmitting the computer program product according to claim 38.
